(19) United States
(12) Patent Application Publication
(10) Pub. No.: US 2026/0156430 A1
(43) Pub. Date: Jun. 4, 2026

(54) 6DOF HIGHER ORDER AMBISONC RENDERING

(71) Applicant: Nokia Technologeis Oy, Espoo (FI)

(72) Inventors: Sujeet Shyamsundar Mate, Tampere (FI); Jussi Artturi Leppänen, Tampere (FI); Lauros Pajunen, Helsinki (FI); Mikko-Ville Laitinen, Espoo (FI); Antti Johannes Eronen, Tampere (FI); Archontis Politis, Tampere (FI)

(21) Appl. No.: 19/121,928

(22) PCT Filed: Sep. 22, 2023
(86) PCT No.: PCT/EP2023/076230

§ 371 Date: Apr. 17, 2025

(30) Foreign Application Priority Data
Oct. 17, 2022 (GB) 2215318.3

(51) Int. Cl. H04S 7/00

(52) U.S. Cl. CPC H04S 7/304; H04S 7/307; H04S 2400/11; H04S 2420/11

(57) ABSTRACT

A method for assisting six degree-of-freedom rendering of an audio scene, the method including: obtaining information associated with at least one audio source, wherein the information associated with the at least one audio source includes: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining audio scene description metadata based on obtained audio scene description information; encoding the information associated with the at least one audio source within the audio scene description metadata, wherein the information associated with the at least one audio source is configured to enable informed rendering.

### FIELD

The present application relates to apparatus and methods for audio rendering with 6 degree-of-freedom of higher order ambisonic audio signals.

### BACKGROUND

Rendering of scenes with 6 degree-of-freedom (6DoF) for listener movement in a scene comprising multiple higher order ambisonic (HOA) sources is part of the MPEG-I Immersive Audio standard working draft (ISO/IEC 23090-4 WD).

6DoF rendering for Multipoint-HOA scenes can be performed without knowledge of position of audio sources in the audio scene. One of the limitations of not knowing the position of the audio sources is that as the listener approaches the audio source(s) of interest by walking closer, the localization diminishes. In order to address the limitation of reduced localization in close proximity and absence of any effect of distance, the use of position of audio source positions can be used.

The availability of audio source positions is helpful for improved subjective quality with improved localization for audio sources when the listener approaches the audio source(s) of interest. This method requires the position for the one or more audio sources of interest, which are not captured separately but are part of the audio mixture capture by the microphone array which is represented as a HOA source in MPEG-I scope. In a general scenario, the audio source represents any active audio source in the audio scene represented by a group of two or more microphone array capture positions or synthetic ambisonics sources.

However, there is a need for controlling the complexity as well as configuration of the renderer according to the content creator or user preferences when there are multiple audio sources of interest whose position is known to the renderer. Consequently, for a scene with multiple audio sources of interest, if all the audio source positions are provided to the renderer, the renderer will perform additional processing for all the audio sources. This will include audio sources which are further away from the listener, thus not bringing any additional benefit while incurring additional rendering complexity.

### SUMMARY

There is provided according to a first aspect a method for assisting six degree-of-freedom rendering of an audio scene, the method comprising: obtaining information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining audio scene description metadata based on obtained audio scene description information; encoding the information associated with the at least one audio source within the audio scene description metadata, wherein the information associated with the at least one audio source is configured to enable informed rendering.

The information associated with the at least one audio source may be configured to be used to enable informed rendering is for guiding parameteric audio processing.

The obtaining audio scene description metadata based on obtained audio scene description information may be generating audio scene description metadata based on obtained audio scene description information.

The at least one audio source may be one or more of: a non-disjoint audio source; an audio source which is not currently represented by an audio source located within the audio scene; and an audio source which is not represented by a further audio stream or audio object.

Obtaining the audio source priority may comprise determining the audio source priority based on at least one of: determining the audio source position relative to a user reachable region; and determining a user input or other input audio source priority value.

The information associated with the at least one audio source may comprise information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin.

Obtaining information associated with at least one audio source may comprise determining frequency bins to be selected for merging based on at least one of: a computational complexity determination of a target playback device; and a determination of a number of frequency bands based on the available bitrate.

The information associated with the at least one audio source within an audio scene description metadata is for the whole audio scene.

Encoding the information associated with the at least one audio source within an audio scene description metadata may comprise encoding the information within a scene payload in a MPEG-I bitstream and in a configuration packet.

Encoding the information associated with the at least one audio source within an audio scene description metadata may comprise encoding the information in a separate payload in a MPEG-H Audio Stream payload packet.

The audio scene may comprise at least two higher order ambisonics sources, and wherein obtaining information associated with at least one audio source may comprise obtaining the information based on the at least two higher order ambisonics sources.

Encoding the information associated with the at least one audio source within an audio scene description metadata may comprise adding the audio source information to at least one higher order ambisonics group within an MPEG-I bitstream.

Obtaining the audio source proximity threshold may comprise determining the audio source proximity threshold based on at least one of: determining an audio level associated with the audio source; determining a distance between at least one of the at least two higher order ambisonics sources and the audio source; determining a distance between a listener and the audio source; determining a user input or other input audio source proximity threshold value.

According to a second aspect there is provided a method for six degree-of-freedom rendering of an audio scene, the method comprising: obtaining a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determining a listener position within the audio scene; selecting at least one audio source based on the listener position, the position of the audio source and at least one of: the audio source proximity threshold; and the audio source priority; rendering an audio signal from the selected at least one audio source.

The audio source priority may be based on at least one of: a determination of the audio source position relative to a user reachable region; and a determination of a user input or other input audio source priority value.

The audio scene may comprise at least two higher order ambisonics sources.

The audio source proximity threshold may be based on at least one of: an audio level associated with the audio source; a distance between at least one of the at least two higher order ambisonics sources and the audio source; a distance between the listener and the audio source; a user input or other input audio source proximity threshold value.

The information associated with the at least one audio source may comprise information configured to indicate which frequency bins are processed individually, which frequency bins are merged into two or more groups and which frequency bins are merged into a single group, wherein rendering a spatialized audio signal from the selected at least one audio source may comprise rendering the spatialized audio signal based on processing the selected at least one audio source on a frequency bin basis determined from the information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin. Selecting at least one audio source based on the listener position, the position of the audio source and at least one of: the audio source proximity threshold; and the audio source priority may comprise: determining two or more audio sources, wherein the two or more audio sources are within a range defined by the position of the listener and the audio source proximity threshold; selecting, from the two or more audio sources, the at least one audio source based on at least one of: the audio source priority; and a distance between the audio source position and the listener position.

According to a third aspect there is provided an apparatus for assisting six degree-of-freedom rendering of an audio scene, the apparatus comprising means configured to: obtain information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtain audio scene description metadata based on obtained audio scene description information; encode the information associated with the at least one audio source within the audio scene description metadata, wherein the information associated with the at least one audio source is configured to enable informed rendering.

The information associated with the at least one audio source may be configured to be used to enable informed rendering is for guiding parameteric audio processing.

The means configured to obtain audio scene description metadata based on obtained audio scene description information may be configured to generate audio scene description metadata based on obtained audio scene description information.

The at least one audio source may be one or more of: a non-disjoint audio source; an audio source which is not currently represented by an audio source located within the audio scene; and an audio source which is not represented by a further audio stream or audio object.

The means configured to obtain the audio source priority may be configured to determine the audio source priority based on determining at least one of: the audio source position relative to a user reachable region; and a user input or other input audio source priority value.

The information associated with the at least one audio source may comprise information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin.

The means configured to obtain information associated with at least one audio source may be configured to determine frequency bins to be selected for merging based on at least one of: a computational complexity determination of a target playback device; and a determination of a number of frequency bands based on the available bitrate.

The information associated with the at least one audio source within an audio scene description metadata is for the whole audio scene.

The means configured to encode the information associated with the at least one audio source within an audio scene description metadata may be configured to encode the information within a scene payload in a MPEG-I bitstream and in a configuration packet.

The means configured to encode the information associated with the at least one audio source within an audio scene description metadata may be configured to encode the information in a separate payload in a MPEG-H Audio Stream payload packet.

The audio scene may comprise at least two higher order ambisonics sources, and wherein the means configured to obtain information associated with at least one audio source may be configured to obtain the information based on the at least two higher order ambisonics sources.

The means configured to encode the information associated with the at least one audio source within an audio scene description metadata may be configured to add the audio source information to at least one higher order ambisonics group within an MPEG-I bitstream.

The means configured to obtain the audio source proximity threshold may be configured to determine the audio source proximity threshold based on determining at least one of: an audio level associated with the audio source; a distance between at least one of the at least two higher order ambisonics sources and the audio source; a distance between a listener and the audio source; determining a user input or other input audio source proximity threshold value.

According to a fourth aspect there is provided an apparatus for six degree-of-freedom rendering of an audio scene, the apparatus comprising means configured to: obtain a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determine a listener position within the audio scene; select at least one audio source based on the listener position, the position of the audio source and at least one of: the audio source proximity threshold; and the audio source priority; render an audio signal from the selected at least one audio source.

The audio source priority may be based on at least one of: a determination of the audio source position relative to a user reachable region; and a determination of a user input or other input audio source priority value.

The audio scene may comprise at least two higher order ambisonics sources.

The audio source proximity threshold may be based on at least one of: an audio level associated with the audio source; a distance between at least one of the at least two higher order ambisonics sources and the audio source; a distance between the listener and the audio source; a user input or other input audio source proximity threshold value.

The information associated with the at least one audio source may comprise information configured to indicate which frequency bins are processed individually, which frequency bins are merged into two or more groups and which frequency bins are merged into a single group, wherein rendering a spatialized audio signal from the selected at least one audio source may comprise rendering the spatialized audio signal based on processing the selected at least one audio source on a frequency bin basis determined from the information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin.

The means configured to select at least one audio source based on the listener position, the position of the audio source and at least one of: the audio source proximity threshold; and the audio source priority may be configured to: determine two or more audio sources, wherein the two or more audio sources are within a range defined by the position of the listener and the audio source proximity threshold; select, from the two or more audio sources, the at least one audio source based on at least one of: the audio source priority; and a distance between the audio source position and the listener position.

According to a fifth aspect there is provided an apparatus for assisting six degree-of-freedom rendering of an audio scene, the apparatus comprising at least one processor and at least one memory storing instructions that, when executed by the at least one processor, cause the system at least to perform: obtaining information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining audio scene description metadata based on obtained audio scene description information; encoding the information associated with the at least one audio source within the audio scene description metadata, wherein the information associated with the at least one audio source is configured to enable informed rendering.

The information associated with the at least one audio source may be configured to be used to enable informed rendering is for guiding parameteric audio processing.

The apparatus caused to perform obtaining audio scene description metadata based on obtained audio scene description information may be further caused to perform generating audio scene description metadata based on obtained audio scene description information.

The at least one audio source may be one or more of: a non-disjoint audio source; an audio source which is not currently represented by an audio source located within the audio scene; and an audio source which is not represented by a further audio stream or audio object.

The apparatus caused to perform obtaining the audio source priority may be further caused to perform determining the audio source priority based on at least one of: determining the audio source position relative to a user reachable region; and determining a user input or other input audio source priority value.

The information associated with the at least one audio source may comprise information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin.

The apparatus caused to perform obtaining information associated with at least one audio source may be caused to further perform determining frequency bins to be selected for merging based on at least one of: a computational complexity determination of a target playback device; and a determination of a number of frequency bands based on the available bitrate.

The information associated with the at least one audio source within an audio scene description metadata is for the whole audio scene.

The apparatus caused to perform encoding the information associated with the at least one audio source within an audio scene description metadata may be further caused to perform encoding the information within a scene payload in a MPEG-I bitstream and in a configuration packet.

The apparatus caused to perform encoding the information associated with the at least one audio source within an audio scene description metadata may be further caused to perform encoding the information in a separate payload in a MPEG-H Audio Stream payload packet.

The audio scene may comprise at least two higher order ambisonics sources, and wherein the apparatus caused to perform obtaining information associated with at least one audio source may be further caused to perform obtaining the information based on the at least two higher order ambisonics sources.

The apparatus caused to perform encoding the information associated with the at least one audio source within an audio scene description metadata may be further caused to perform adding the audio source information to at least one higher order ambisonics group within an MPEG-I bitstream.

The apparatus caused to perform obtaining the audio source proximity threshold may be further caused to perform determining the audio source proximity threshold based on at least one of: determining an audio level associated with the audio source; determining a distance between at least one of the at least two higher order ambisonics sources and the audio source; determining a distance between a listener and the audio source; determining a user input or other input audio source proximity threshold value.

According to a sixth aspect there is provided an apparatus for six degree-of-freedom rendering of an audio scene, the apparatus comprising at least one processor and at least one memory storing instructions that, when executed by the at least one processor, cause the system at least to perform: obtaining a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determining a listener position within the audio scene; selecting at least one audio source based on the listener position, the position of the audio source and at least one of: the audio source proximity threshold; and the audio source priority; rendering an audio signal from the selected at least one audio source.

The audio source priority may be based on at least one of: a determination of the audio source position relative to a user reachable region; and a determination of a user input or other input audio source priority value.

The audio scene may comprise at least two higher order ambisonics sources.

The audio source proximity threshold may be based on at least one of: an audio level associated with the audio source; a distance between at least one of the at least two higher order ambisonics sources and the audio source; a distance between the listener and the audio source; a user input or other input audio source proximity threshold value.

The information associated with the at least one audio source may comprise information configured to indicate which frequency bins are processed individually, which frequency bins are merged into two or more groups and which frequency bins are merged into a single group, wherein the apparatus caused to perform rendering a spatialized audio signal from the selected at least one audio source may be further caused to perform rendering the spatialized audio signal based on processing the selected at least one audio source on a frequency bin basis determined from the information configured to indicate which frequency bins are processed individually, which frequency bins are merged into two or more groups and which frequency bins are merged into a single group.

The information may comprise at least one of: a highest frequency bin index configured to indicate a highest frequency bin index upto which frequency bins are processed individually; a lowest frequency bin index configured to indicate a lowest frequency bin index above which frequency bins are merged and treated as a single frequency bin; and a merge indicator configured to indicate a range of frequency bins in which frequency bins are merged and treated as a single frequency bin.

The apparatus caused to perform selecting at least one audio source based on the listener position, the position of the audio source and at least one of: the audio source proximity threshold; and the audio source priority may be caused to further perform: determining two or more audio sources, wherein the two or more audio sources are within a range defined by the position of the listener and the audio source proximity threshold; selecting, from the two or more audio sources, the at least one audio source based on at least one of: the audio source priority; and a distance between the audio source position and the listener position.

According to a seventh aspect there is provided an apparatus for assisting six degree-of-freedom rendering of an audio scene, the apparatus comprising: means for obtaining information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; means for obtaining audio scene description metadata based on obtained audio scene description information; means for encoding the information associated with the at least one audio source within the audio scene description metadata, wherein the information associated with the at least one audio source is configured to enable informed rendering.

According to an eighth aspect there is provided an apparatus for six degree-of-freedom rendering of an audio scene, the apparatus comprising: means for obtaining a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; means for determining a listener position within the audio scene; means for selecting at least one audio source based on the listener position, the position of the audio source and at least one of: the audio source proximity threshold; and the audio source priority; means for rendering an audio signal from the selected at least one audio source.

According to a ninth aspect there is provided an apparatus for assisting six degree-of-freedom rendering of an audio scene, the apparatus comprising: obtaining circuitry configured to obtain information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining circuitry configured to obtain audio scene description metadata based on obtained audio scene description information; encoding circuitry configured to encode the information associated with the at least one audio source within the audio scene description metadata, wherein the information associated with the at least one audio source is configured to enable informed rendering.

According to a tenth aspect there is provided an apparatus for six degree-of-freedom rendering of an audio scene, the apparatus comprising: obtaining circuitry configured to obtain a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determining circuitry configured to determine a listener position within the audio scene; means for selecting at least one audio source based on the listener position, the position of the audio source and at least one of: the audio source proximity threshold; and the audio source priority; rendering circuitry configured to render an audio signal from the selected at least one audio source.

According to an eleventh aspect there is provided a computer program comprising instructions [or a computer readable medium comprising instructions] for causing an apparatus for assisting six degree-of-freedom rendering of an audio scene, the apparatus caused to perform at least the following: obtaining information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining audio scene description metadata based on obtained audio scene description information; encoding the information associated with the at least one audio source within the audio scene description metadata, wherein the information associated with the at least one audio source is configured to enable informed rendering.

According to a twelfth aspect there is provided a computer program comprising instructions [or a computer readable medium comprising instructions] for causing an apparatus for six degree-of-freedom rendering of an audio scene, the apparatus caused to perform at least the following: obtaining a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determining a listener position within the audio scene; selecting at least one audio source based on the listener position, the position of the audio source and at least one of: the audio source proximity threshold; and the audio source priority; rendering an audio signal from the selected at least one audio source.

According to a thirteenth aspect there is provided a non-transitory computer readable medium comprising program instructions for causing an apparatus for assisting six degree-of-freedom rendering of an audio scene, the apparatus caused to perform at least the following: obtaining information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; obtaining audio scene description metadata based on obtained audio scene description information; encoding the information associated with the at least one audio source within the audio scene description metadata, wherein the information associated with the at least one audio source is configured to enable informed rendering.

According to a fourteenth aspect there is provided a non-transitory computer readable medium comprising program instructions for causing an apparatus for six degree-of-freedom rendering of an audio scene, the apparatus caused to perform at least the following: obtaining a spatialized audio bitstream, the spatialized audio bitstream comprising audio scene description metadata, the audio scene description metadata comprising information associated with at least one audio source, wherein the information associated with the at least one audio source comprises: a position of the audio source; and at least one of: an audio source priority, the audio source priority configured to define a priority of the audio source within the audio scene; and an audio source proximity threshold, the audio source proximity threshold defining a threshold distance within which the audio source is present; determining a listener position within the audio scene; selecting at least one audio source based on the listener position, the position of the audio source and at least one of: the audio source proximity threshold; and the audio source priority; rendering an audio signal from the selected at least one audio source.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an examply audio scene comprising audio sources within which a listener can move with 6 DoF movement;

FIG. 2 shows an example of the implementation of embodiment described herein with respect to selection of audio sources;

FIG. 3 shows schematically a suitable system of apparatus for implementing some embodiments;

FIG. 4 shows a flow diagram of the operations of the rendering apparatus shown in FIG. 3 according to some embodiments; and

FIG. 5 shows schematically an example device suitable for implementing the apparatus shown.

### EMBODIMENTS OF THE APPLICATION

The concept as discussed herein in further detail with respect to the following embodiments is related to the rendering of audio scenes within which the listener is able to move within the scene with 6DoF and the scene comprises one or more higher order amibsonic audio sources. 6DoF is presently a commonplace in virtual reality, such as VR games, where movement at the audio scene is straightforward to render as all spatial information is readily available (i.e., the position of each sound source as well as the audio signal of each source separately).

In the following a non-disjoint audio source is understood to be an audio source which is not captured as an individual audio source but exists as part of the audio mixture, comprising the audio scene captured from a far-field microphone array or plurality of HOA sources.

For brevity and simplicity, the term non-disjoint audio source and audio source are used interchangeably in the following.

As discussed above the availability of audio source positions is helpful for improved subjective quality with improved localization for audio sources when the listener approaches the audio source(s) of interest. Such methods require the position for the one or more audio sources of interest, which are not captured separately but are part of the audio mixture capture by the microphone array which is represented as a HOA source in MPEG-I scope.

However, a system needs to consider the complexity of the rendering as well as the configuration of the renderer based on the content creator or user preferences when there are multiple audio sources of interest whose position is known to the renderer. Consequently, for a scene with multiple audio sources of interest, if all the audio source positions are provided to the renderer, the renderer will execute or perform processing for all the audio sources. This processing includes sources which are further away from the listener, and which do not bring significant or (in some cases) any additional benefit while incurring additional processing complexity.

In some embodiments there is provided apparatus and methods enabling the configuration and control of a renderer in order to provide a listening experience where the localization of the audio source(s) of interest in the scene is maintained and the effect of distance (to the informed audio source with respect to the listener) is pronounced even as the listener approaches closer to the the audio source(s) of interest. Furthermore, the apparatus and methods aim to achieve this without a significant increase in computational complexity even in complex scenes where such improved subjective experience is possible for a large number of audio source(s) of interest. The aim of the embodiments herein is to improve the subjective listening experience with efficient use of computational resources.

Furthermore the aim of the embodiments discussed herein is to retain the ability of the listener to localize for audio sources (for example based on spatial cues) in an audio scene comprising multiple HOA sources even where the listener position is relatively close to the audio source).

The concept as discussed in the following embodiments in further detail is one which relates to apparatus and methods for controlling 6DoF binaural rendering of an audio scene comprising two or more HOA sources. In these embodiments there can comprise apparatus and methods for transmitting information of non-disjoint audio source(s) of interest. The non-disjoint audio source information can comprise the position (of the source) in the audio scene, and a proximity threshold. This audio source information can in some embodiments be used to enable informed rendering for guiding parameteric audio processing to achieve improved subjective listening experience with higher localization by enhancing overall computational efficiency and limiting computational complexity for the use of informed mode processing. This results in not performing additional informed mode rendering related processing based on the threshold distance for audio source(s) that are too far to benefit from informed mode render processing.

In some embodiments this is achieved by an encoder and encoding method comprising:
obtaining the position of the one or more audio source(s) of interest;
determining audio source priority based on at least one or more of the following: the audio source position within or outside the user reachable region; any other externally provided prioritization information;
determining the audio source proximity threshold based on at least one or more of the following: an audio level; a distance between the audio source and HOA source; a distance between audio source and the listener; priority of the audio source in the audio scene and any other externally provided information;
encoding the informed source rendering information comprising position, priority and informed mode enabling proximity threshold within the audio scene description metadata carried in the 6DoF rendering bitstream.

Additionally in some embodiments a renderer and rendering method comprises:
obtaining the informed source rendering information if present in the 6DoF bitstream;
wherein the informed source information comprises an informed source position; and at least one of the following; proximity threshold distance with respect to the listener position and which can be designated ‘listener2informedsource’ threshold; proximity threshold distance with respect to HOA source and which can be designated ‘HOAsource2informedsource’ threshold; a maximum simultaneous number of HOA sources and which can be designated ‘MaxSimultaneousHOAsources’; and an informed source priority identifier (though in some embodiments this priority information is implicit and defined based on a proximity to the listener); determining based on listener proximity threshold distance the one or more informed sources that need to be rendered;
determining based on HOA source proximity threshold distance the HOA sources that should not be used for rendering each of the informed sources selected to be rendered based on listener proximity;
performing informed mode processing for the selected one or more informed sources using the closest HOA source which has not been excluded based on the HOA source proximity threshold distance.

In some embodiments where two or more audio sources are within the proximity threshold, a priority value can be used to select the audio source for informed mode rendering.

The audio source information, in some embodiments, is added as a defined informedSourceInfoStruct( ) to the HOA group in the MPEG-I bitstream. In some embodiments the audio source information is specific to an informed source in a HOA group. In some other embodiments the audio source information is common for all informed sources in a HOA group or common for all HOA groups. However in some embodiments the audio source information is a mix or combination of all the above.

Thus for example in some embodiments the audio source information comprising the proximity threshold can be the same for the entire scene (in other words all HOA groups in a scene) or for each HOA group.

In some embodiments, the audio source information for configuring the renderer for 6DoF rendering is delivered as part of the scene payload in the MPEG-I bitstream and an updated scene payload is delivered in the configuration packet.

The audio source information for configuring the renderer for 6DoF rendering, in some embodiments, is delivered as a separate payload in the MHAS payload packet.

In some embodiments the apparatus and method is configured to control the computational complexity of 6DoF binaural rendering of an audio scene with 2 or more HOA sources. In such embodiments information is transmitted to indicate which frequency bins are processed individually, which frequency bins are merged into two or more groups and which frequency bins are merged into a single group. This aims therefore to reduce the computational complexity due to the reduced number of frequency bins for performing the spatial metadata interpolation and 6DoF binaural rendering. In such embodiments the computational complexity is reduced while maintaining high subjective quality.

In some embodiments, the transmitted information comprises:
a highest frequency bin index until which all the frequency bins are processed without modifications;
a lowest index indicating all the frequency bins including and above are merged and treated as a single bin; and
an ERB based merge method for combining frequency bins in the intermediate range between the above two indices.

In some further embodiments, the frequency bins selected for no-modification and merging is determined according to at least one or more of the following: a computational complexity budget of the target playback device and the number of frequency bands budgeted based on the available bitrate. In some embodiments, subjective and/or objective quality of the rendered audio is used as a parameter for selecting the frequency bin configuration parameters which provide a good quality.

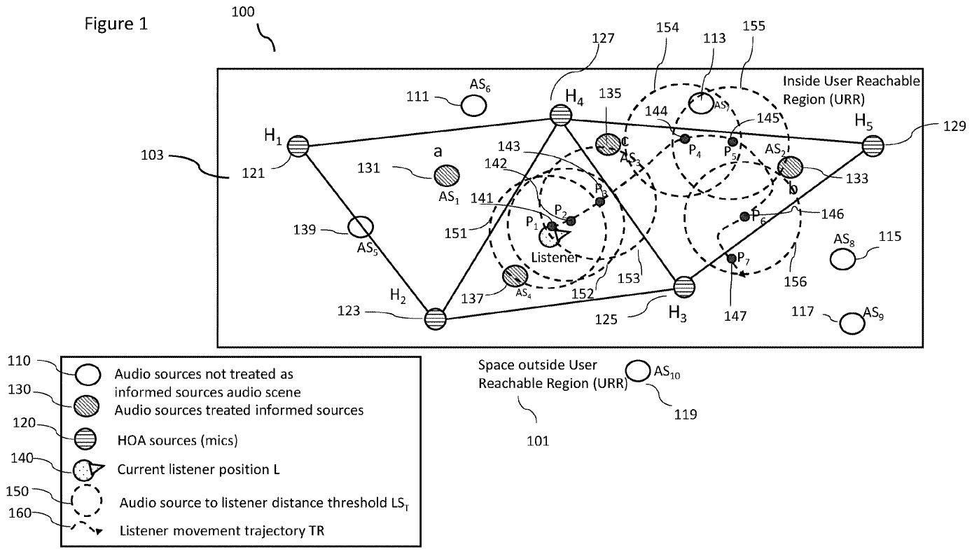

With respect to FIG. 1 illustrates an example audio scene, within which some embodiments can be implemented. In the example shown in FIG. 1 the audio scene 100 comprises five HOA sources 120. The example number of HOA sources is to assist the understanding of the concept as discussed herein and in some other examples there can be more then five or less than five HOA sources. The HOA sources shown in FIG. 1 are denoted H₁ 121, H₂ 123, H₃ 125, H₄ 127, H₅ 129. In some embodiments the HOA sources 120 are implemented as microphone or microphone arrays configured to generate the HOA signals. These HOA source microphones can be located about the audio scene.

The audio scene 100 furthermore comprises multiple audio sources. The example audio scene shows ten audio sources (but in other examples there can be more or fewer numbers of audio sources). In the example shown in FIG. 1 the audio sources are denoted AS₁ 131, AS₂ 133, AS₃ 135, AS₄ 137, AS₅ 139, AS₆ 111, AS₇ 113, AS₈ 115, AS₉ 117, AS₁₀ 119. In the following the audio sources AS₁ 131, AS₂ 133, AS₃ 135, AS₄ 137, AS₅ 139 are the audio sources of interest. It is to be noted that in this example none of the audio sources exist as a separate entity (e.g., audio objects). The audio sources discussed herein are present in the audio signal of the HOA sources H₁ to H₅ as a mixture of the audio signals emitted from all the audio sources in the audio scene.

In this example an end user or listener 140 can traverse the audio scene freely with six degrees of freedom (6DoF). The listener 140 experiencing the audio scene with movement is represented by a trajectory TR 160. Additionally along the trajectory TR 160 are shown a series of positions, which can be the position at a series of times. In the example shown in FIG. 1 are the positions P₁ 141, P₂ 142, P₃ 143, P₄ 144, P₅ 145, P₆ 146, P₇ 147 along the trajectory TR for succeeding times T₁ to T₇.

In the embodiments described herein the example audio sources of interest are desired to be rendered by utilizing the audio source position to perform informed rendering by guiding the parameteric audio processing to achieve improved localization. In the example audio scene shown in FIG. 1, a conventional implementation of the informed mode rendering which implements an ‘informed mode’ processing for all the audio sources of interest for the duration of the audio scene consumption. The informed mode render processing is thus required for each audio source of interest which is to be rendered as informed source.

In the following embodiments the audio sources which are within the proximity of the audio source to listener threshold or LS_{T} (denoted by reference 150 and shown for positions P₁ 141, P₂ 142, P₃ 143, P₄ 144, P₅ 145, P₆ 146 as threshold regions 151, 152, 153, 154, 155, 156 respectively as are rendered with informed mode processing. In the specified example shown in FIG. 1, the listener traverses positions along the trajectory TR, where at different positions listed below, the informed mode rendering is initiated or stopped depending on the proximity to the audio sources of interest that are specified to be rendered as informed sources.

In the following embodiments an informed sources specified in the bitstream is rendered with informed render processing, it is referred to as an active informed source. Similarly, where an informed source specified in the bitstream is not rendered with informed render processing, it is referred to as inactive informed source. In order to efficiently utilize the computational resources of the renderer, not all informed sources specified in the bitstream will be rendered as active informed sources all the time due to the various other control parameters to regulate the selection of informed sources to be rendered as active informed sources. This terminology is used to assist the understanding of the following examples.

In the following example the Listener 140 starts consuming the content at position P₁ and time T₁. Subsequently, the Listener walks (or otherwise moves) to position P₂ at time T₂, position P₃ at time T₃, position P₄ at time T₄, position P₅ at time T₅, position P₆ at time T₆ and stops listening to the audio scene at position P₇ and time T₇.

With respect to Position P₁: The listener position P₁ is such that the audio source AS₄ 137 is within the LS_{T} 151 associated with P₁ 141 consequently AS₄ 137 is rendered as informed source. However, none of the other audio sources of interest are rendered as an informed source.

With respect to Position P₂: The audio source AS₄ 137 is no longer within the LS_{T} 152 associated with P₂ 142, consequently, AS₄ 137 is not rendered as an informed source anymore.

With respect to Position P₃: Subsequently, the audio source AS₃ 135 is within the LS_{T} 153 associated with P₃ 143 consequently AS₃ 135 is rendered as an informed source at this position.

With respect to Position P₄: At this position, the audio source AS₃ 135 is no longer within the LS_{T} 154 associated with P₄ 144, consequently, AS₃ 135 is no longer rendered as an informed source.

With respect to position P₅: At this position, informed source rendering is initiated for AS₂ 133 (as the audio source AS₂ 133 is within the LS_{T} 155).

With respect to Position P₆: As the listener approaches this position, the informed source rendering for AS₂ 133 is stopped as the audio source is no longer within the LS_{T} 156.

With respect to Position P₇: At this position P₇ 147 the Listener is outside the HOA source constellation and does not lie within any of the triangles formed by the HOA sources H₁ 121 to H₅ 129 in the audio scene 100. In this example, there is no proximal audio source of interest. However, if such a proximal audio source was present, the informed mode rendering would be processed normally. Furthermore, if the audio source of interest is positioned outside the triangulated area, the exterior mode (as described in EP 21201766.9) rendering can be adjusted with the informed source position. i.e., the distance from the edge of the triangulated area to the informed source is used directly as the exterior projection radius in the exterior rendering. If no informed source is active, the average distance to all the informed sources outside the triangulated area can be used as the projection radius.

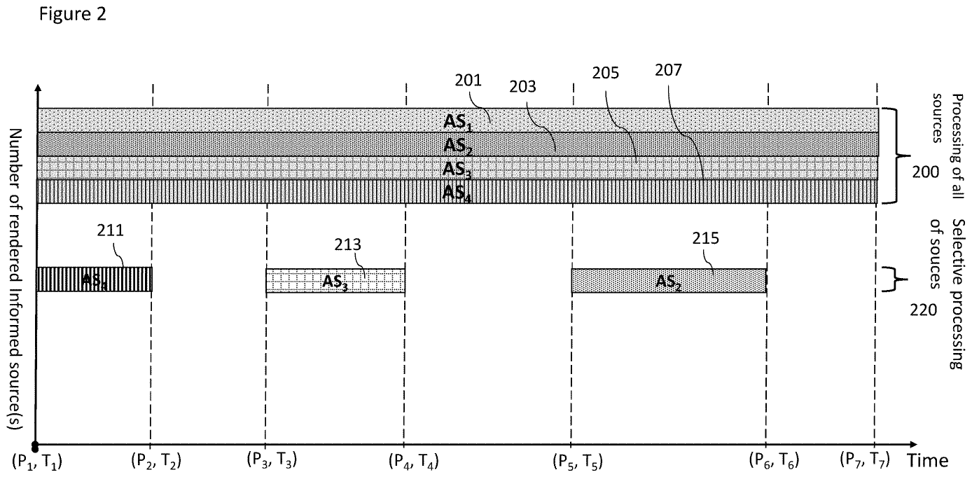

The effect of the listener motion within the example audio scene as shown in FIG. 1 as processed according to the embodiments described herein and a known (processing of all sources) method is shown in FIG. 2.

The top section 200 shows a known rendering or processing of ‘all’ sources method where from time T₁ to T₇ the rendering or processing is configured to render the output audio signal with the informed sources AS₁ for period 201 from T₁ to T₇, AS₂ for period 203 from T₁ to T₇, AS₃ for period 205 from T₁ to T₇ and AS₄ for period 207 from T₁ to T₇. However as shown by the bottom section 220 which shows a selective processing or rendering according to some embodiments the rendering of the output audio signals is based on AS₄ for period 211 from T₁ to T₂, AS₃ for period 213 from T₃ to T₄, and AS₂ for period 215 from T₅ to T₆.

The difference between the selective informed source processing or rendering according to some embodiments and the all informed source processing approach is, for this example, shown for the positions on the Listener trajectory TR between P₁ and P₂, where all the 4 informed sources (AS₁ to AS₄) are active whereas the AS₄ is rendered as active informed source, with the other sources AS₁ to AS₃ are inactive informed sources.

For the positions between P₂ and P₃, the all informed source processing method is configured to process all of the 4 informed sources (AS₁ to AS₄) as active informed sources. In contrast, the method according to some embodiments is configured with no active informed source.

For the positions between P₃ and P₄, for this example all the 4 informed sources (AS₁ to AS₄) are active whereas the AS₃ is rendered as an active informed source, with the other sources AS₁, AS₂ and AS₄ are inactive informed sources.

For the positions between P₄ and P₅, according to the method applied in the embodiments herein there are no active informed source (which compares to all the 4 informed sources (AS₁ to AS₄) being active in the conventional approach.

For the positions between P₅ and P₆, there is one active informed source (AS₂) and the other sources are inactive informed sources in the embodiments as described herein whereas there are 4 active informed sources (AS₁ to AS₄) in the conventional method.

For the position between P₆ and P₇, there are no active informed source (which compares to all the 4 informed sources (AS₁ to AS₄) being active in the conventional approach.

Thus, it is can be deduced that the application of the embodiments described herein enables a reduced overall complexity while providing the ability to control the adverse impact on the subjective quality compared. Furthermore, the following control aspects can be highlighted when applying the embodiments described herein:
A reduction of the number of maximum simultaneously rendered informed sources;
A reduction to zero of the number of informed sources depending on the listener position;

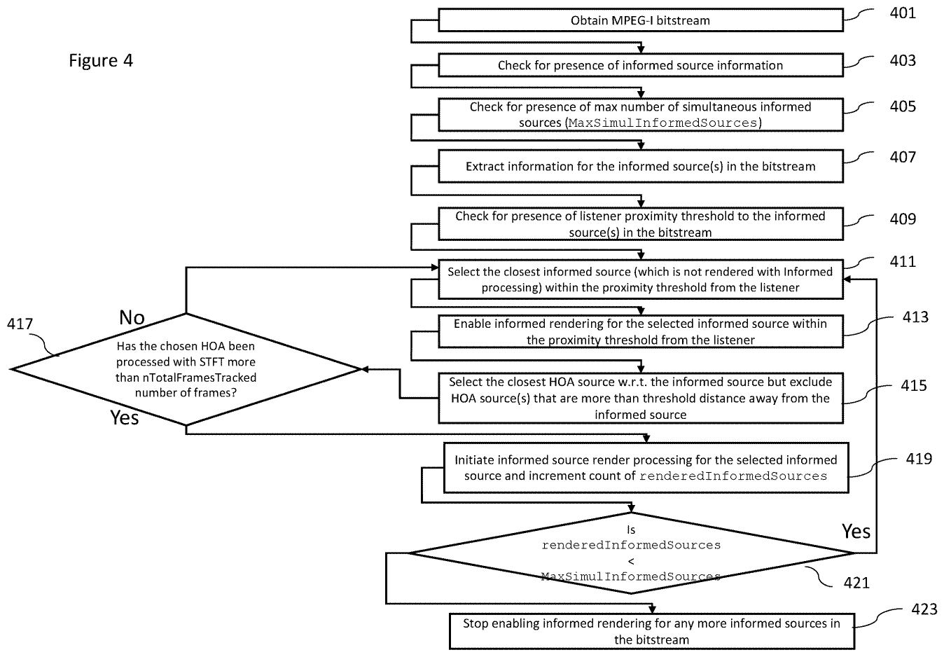

A commercial deployment embodiment of the invention is described in FIG. 4. The figure illustrates an end to end system overview for an audio scene comprising multiple HOA sources, rendered with high quality localization assisted by information regarding audio sources of interest and configuring the informed mode processing based on the control data specified in the invention. This enables achieving high quality subjective listening experience without the need to have exorbitant computational resources even for complex scenes with large number of audio sources of interest.

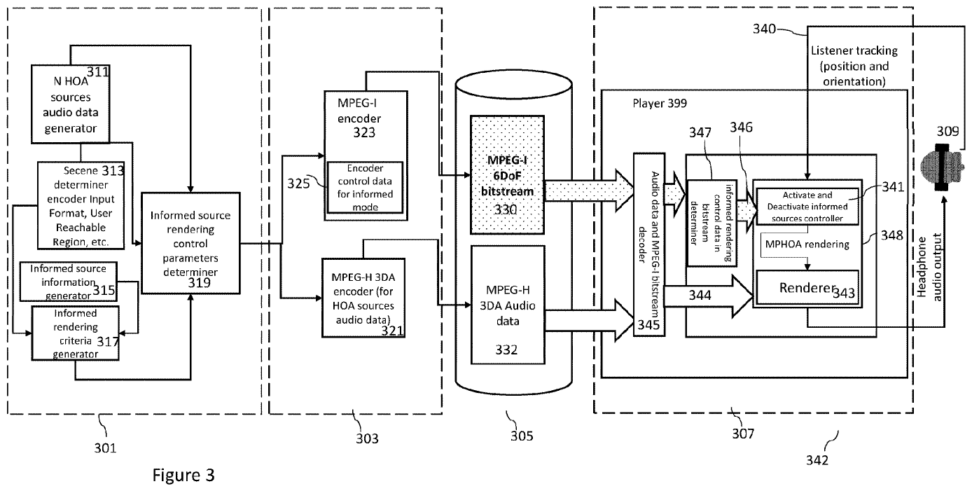

With respect to FIG. 3 is shown schematically an example system where the embodiments are implemented in an authoring device 301 which generates the audio stream, an encoder device 303 which encodes and writes data into a bitstream, a server device 305, which stores the bitstream and a playback device 307, which decodes the bitstream, performs reverberator processing according to the embodiments and outputs audio for headphone listening. Although FIG. 3 shows the authoring device 301, the encoder device 303, the server device 305, and the playback device 307 as separate devices it would be understood that in some embodiments functionality of these devices can be combined into a one or more physically separate devices. For example in some embodiments the authoring and encoder devices are a single device or a single device or apparatus implements the functions of all of the authoring device 301, the encoder device 303, the server device 305, and the playback device 307. The authoring device and encoder devices can be implemented on computers and/or network server computers. Furthermore in some embodiments the authoring device and encoder devices can be implemented on an end-user-device, which can be a mobile device, personal computer, sound bar, tablet computer, car media system, home HiFi or theatre system, head mounted display for AR or VR, smart watch, or any suitable system for audio consumption.

In some embodiments the authoring device 301 comprises a (N) HOA sources audio data generator 311 which is configured to generate or otherwise obtain the N HOA source audio data. For example in some embodiments the (N) HOA sources audio data generator is configured to receive the audio signals from the microphone arrays, generate the HOA source audio data synthetically or a combination of the received or synthesized HOA audio data. The HOA sources audio data is passed to a informed source rnedeing controls parameters determiner 319.

In some embodiments the authoring device 301 comprises a scene determiner encoder. The scene determiner is configured to generate information about the audio scene such as Input Format, User Reachable Region, etc. Generally, the audio scene description information can comprise an acoustically relevant description of the contents of the virtual scene, and contains, for example, the scene geometry as a mesh or voxel, acoustic materials, acoustic environments with reverberation parameters, positions of sound sources, and other audio element related parameters such as whether reverberation is to be rendered for an audio element or not.

This scene information is passed to the informed source rendering control parameters determiner 319 and the informed rendering criteria generator 317.

Additionally the authoring device 301 comprises an informed source information generator 315 which is configured to generate informed source information and pass this to the informed rendering criteria generator 317. The informed source information generator 315 in some embodiments is configured to generate the following structures used in the WD of the ISO/IEC 23090-4.

```
payloadScene( ){
  unsigned int(8) sceneDuration;
  unsigned int(1) sceneType;
  transforms( );
  anchors( );
  audioStreams( );
  materials( );
  directivities( );
  primitives( );
  meshes( );
  environments( );
  objectSources( );
  hoaGroups( );
  hoaSources( );
  channelSources( );
}
```

where the hoaGroups( ) structure can be defined as

```
hoaGroups( ){
  unsigned int(8) hoaGroupsCount;
  for(int i=0; i<hoaGroupsCount){
    unsigned int(1) hoaGroupId;
    unsigned int(1) hoaGroupHasRegion;
    unsigned int(1) hoaGroupHasInformedSources;
    if(hoaGroupHasRegion) {
      unsigned int(16) hoaGroupRegionId;
    }
    if(hoaGroupHasInformedSources){
      unsigned int(16) informedSourceCount;
      unsigned int(8) MaxSimulInformedSources;
      for(int j = 0; j < informedSourceCount; j++){
        InformedSourceInfoStruct( );
      }
    }
  }
}
```

In some embodiments the structure for controlling informed mode in the MPEG-I specification can be as follows:

```
InformedSourceInfoStruct( ){
  unsigned int(16) informedSourceId;
  unsigned int(32) positionX;
  unsigned int(32) positionY;
  unsigned int(32) positionZ;
  unsigned int(1) listenerThresholdPresent;
  unsigned int(1) hoaSourceThresholdPresent;
  if(listenerThresholdPresent)
    unsigned int(16) lpdInformedSourceEnableThreshold;
  if(hoaSourceThresholdPresent)
    unsigned int(16) hpdInformedSourceEnableThreshold;
  unsigned int(2) disableInformedSourceType;
  if(disableInformedSourceType==3)
    unsigned int(16) disableInformedSourceThreshold;
  unsigned int(6) priorityValue;
}
```

The informed source rendering metadata is in some embodiments included in the hoaGroups( ) structure of the scene description payload in the MPEG-I bitstream.

hoaGroupHasInformedSources defines a value equal to 0 indicates that the 6DoF HOA rendering for that particular HOA group does not have any information regarding any informed source of interest in the bitstream. A HOA group with such a value shall not perform 6DoF HOA rendering with informed mode related processing. A value equal to 1 indicates presence of information regarding one or more audio source(s) of interest to be rendered as an informed source.

MaxSimulInformedSources indicates the maximum number of active informed sources for a particular HOA group. This parameter can also be used to control the upper bound for the computational complexity. Consequently a convenient mechanism to define the renderer operating level. In different implementation embodiments, the bitstreams with different value can be generated for different capability rendering devices.

informedSourceCount indicates the number of informed sources for a particular HOA group.

The semantics of InformedSourceInfoStruct( ) can be as follows:
informedSourceId indicates a unique identifier for the informed source.
posX indicates the position of the informed source in cartesian coordinate X axis (with unit of millimeters) with reference to the origin of the audio scene coordinates system.
posY indicates the position of the informed source in cartesian coordinate Y axis (with unit of millimeters) with reference to the origin of the audio scene coordinates system.
posZ indicates the position of the informed source in cartesian coordinate Z axis (with unit of millimeters) with reference to the origin of the audio scene coordinates system.
listenerThresholdPresent a value equal to 1 indicates the presence of audio source or informed source distance threshold with respect to the listener position in the audio scene. A value equal to 0 indicates the absence of any such listener proximity threshold.

This threshold is helpful to avoid informed source rendering of distant audio source(s) with respect to the listener.

hoaSourceThresholdPresent a value equal to 1 indicates the presence of audio source or informed source distance threshold with respect to the HOA source position in the audio scene. A value equal to 0 indicates the absence of any such HOA source proximity threshold.

This threshold is helpful to avoid informed source rendering of distant audio source(s) with respect to the HOA source(s).

lpdInformedSourceEnableThreshold specifies the proximity threshold distance between the listener and any informed source in millimeters. If the listener is at a distance less than this threshold from any informed source, the informed mode processing is enabled for the corresponding one or more informed source(s).

hpdInformedSourceEnableThreshold specifies the proximity threshold distance between the HOA source and any informed source in millimeters. If the HOA source is at a distance greater than this threshold from any informed source, the HOA source shall not be utilized for performing informed mode processing for the corresponding one or more informed source(s).

disableInformedSourceType specifies the type of criteria used to disable informed mode rendering when the listener, the audio source of interest (or informed source), the HOA source moves resulting in a distance which is again greater than the proximity threshold specified to enable the informed mode processing for the one or more informed source(s). The type value ‘00’ adds a 10% of the lpdInformedSourceEnableThreshold in order to disable the informed source A of ‘01’ adds processing. value a 20% of the lpdInformedSourceEnableThreshold in order to disable the informed source processing. A value of ‘10’ results in explicitly specifying the proximity threshold value to disable informed source processing via disableInformedSourceThreshold in order to disable the informed source processing.

priorityValue specifies the importance of this source for informed mode rendering. This value is used to disable less important sources from informed mode rendering when the maximum limit of active informed mode sources is reached. This value is also useful in order to determine if an informed source which is within the proximity of the listener or a HOA source is activated as an informed source. The priority value is typically set by the content creator depending on the expected subjective listening experience with close proximity to the listener. For example, there may be 2 informed sources (a singer and a fountain) close to each other. In such a case the priority assigned by the content creator with higher priority for the singer compared to the fountain indicates that the renderer would prefer rendering the singer in case of hitting the upper limit in terms of maximum number of simultaneously active informed sources.

For a given value of MaxSimulInformedSources (in order to constrain the upper limit of computational complexity with informed mode rendering), for a given listener position, for different priority informed sources in less than proximity threshold distance (lpdInformedSourceEnableThreshold), first the specified informed sources are filtered based on priority level (priorityValue), if more than simultaneous threshold are closer than proximity threshold distance (after priority sorting), then the sorting for selection of active informed sources is based on proximity to the listener position.

In some embodiments the structure for controlling informed mode in the MPEG-I specification can be as follows:

```
InformedSourceInfoStruct( ){
  unsigned int(16) informedSourceId;
  InformedSourcePositionStruct( );
  unsigned int(1) listenerThresholdPresent;
  unsigned int(1) hoaSourceThresholdPresent;
  if(listenerThresholdPresent)
    unsigned int(16) lpdInformedSourceEnableThreshold;
  if(hoaSourceThresholdPresent)
    unsigned int(16) hpdInformedSourceEnableThreshold;
  unsigned int(2) disableInformedSourceType;
  if(disableInformedSourceType==3)
    unsigned int(16) disableInformedSourceThreshold;
  unsigned int(6) priorityValue;
}
InformedSourcePositionStruct( ){
  unsigned int(1) isStatic;
  if(isStatic){
    unsigned int(32) positionX;
    unsigned int(32) positionY;
    unsigned int(32) positionZ;
  }
  else{
    unsigned int(2) updateType;
    if(updateType==0)
      mpegiSceneUpdateStruct( );// see 5.2.1.2.2 in [1]
    else if (updateType==2)
        (DynamicUpdateInterface(unsigned int(32) PosX,
unsigned int(32) PosY, unsigned int(32) PosZ);
  }
}
```

Additionally with regards to reducing the computational complexity the following information can be signaled by the bitstream. The frequency band configuration can be delivered by extending the bitstream data structures. The payloadScene( ) structure can be as follows

```
payloadScene( ){
  unsigned int(8) sceneDuration;
  unsigned int(1) sceneType;
  transforms( );
  anchors( );
  audioStreams( );
  materials( );
  directivities( );
  primitives( );
  meshes( );
  environments( );
  objectSources( );
  hoaGroups( );
  hoaSources( );
  channelSources( );
}
```

The payloadScene( ) carries the hoaGroups( ) data structure, which is extended to include the configuration information to control computational complexity. The bitstream for configuration of frequency bins can furthermore in some embodiments be carried as part of the mpegiSceneConfig( ) packet, delivered in config packet, since in many scenarios, this information is not expected to change over time for a given scene.

```
hoaGroups( ){
  unsigned int(8) hoaGroupsCount;
  for(int i=0; i<hoaGroupsCount){
    unsigned int(1) hoaGroupId;
    unsigned int(1) hoaGroupHasFreqBandConfig;
    unsigned int(1) hoaGroupHasRegion;
    if(hoaGroupHasRegion) {
      unsigned int(16) hoaGroupRegionId;
  }
    if(hoaGroupHasFreqBandConfig) {
      unsigned int(8) highestSingleBinBandsIndex;
      unsigned int(8) lowestHighBandIndex;
      unsigned int(8) intermediateBandsERBWidth;
  }
}
```

hoaGroupHasFreqBandConfig defines a value equal to 0 indicates that the 6DoF HOA rendering utilizes all the frequency bins specified in the Appendix A.6 of WDO version 2 of ISO/IEC 23090-4. A value equal to 1 indicates that the 6DoF HOA rendering utilizes the frequency bins specified in Appendix A.6 of WDO of version 2 of ISO/IEC 23090-4 according to the configuration.

highestSingleBinBands Index indicates the highest bin index until which all the frequency bins specified in Appendix A.6 of WDO of ISO/IEC 23090-4 are used as single bins for the subsequent rendering for the particular HOA group.

lowestHighBandIndex indicates the lowest bin index, including and above, all the frequency bins are merged and treated as a single bin for the subsequent rendering for the particular HOA group.

intermediateBandsERBWidth indicates the ERB width for merging the frequency bins in between the highestSingleBinBandsIndex and the lowestHighBandIndex.

In another implementation for the computational complexity reduction, the configuration information for reducing the number of frequency bins is delivered as a separate MPHOA payload bitstream instead of the data structure extending the payloadScene( ).
The MPHOA payload bitstream carries the information described as follows:

```
payloadMPHOA( ){
  unsigned int(8) hoaGroupId;
  unsigned int(1) hoaGroupHasFreqBandConfig;
  unsigned int(1) hoaGroupData;
  unsigned int(1) hoaGroupData;
  if(hoaGroupHasGroupData){
    HoaGroupDataStruct( );
  }
  if(hoaGroupHasFreqBandConfig){
    HOAGroupFreqBandConfigStruct( );
  }
}
HoaGroupDataStruct{
  unsigned int(8) hoaGroupId;
  unsigned int(8) numHOASourcesInGroup;
  for(int i=0; i<numHOASourcesInGroup;i++){
    unsigned int(8) hoaSourceId;
    HOASourcePositionStruct( );
    HOASourceOrientationStruct( );
    unsigned int(8) hoaOrder;
  }
}
HoaGroupFreqBandConfigStruct{
  unsigned int(8) highestSingleBinBandsIndex;
  unsigned int(8) lowestHighBandIndex;
  unsigned int(8) intermediateBandsERBWidth;
}
```

The MPHOA payload can be an additional payload type in the PACTYP_MPEGI_PLD MHAS packet. The additional type of payload extends the structure mpegiScenePayload( ) described in the ISO/IEC 23090-4 WDO version 2.

| mpeghiScenePayload( ) | | |
|---|---|---|
| { | | |
| payloadId; | 16 | uimsbf |
| payloadCount; | 16 | uimsbf |
| for(int i = 0; i < payloadCount; i++){ | | |
| payloadType; | 11 | uimsbf |
| payloadLabel; | 2 | uimsbf |
| payloadLength; | 59 | uimsbf |

```
    switch(payloadType){
      case PLD_DIRECTIVITY:{
        payloadDirectivity( );
        break;
      }
      case PLD_DIFFRACTION:{
        payloadDiffraction( );
        break;
      }
      case PLD_EARLY_REFLECTIONS:{
        payloadEarlyReflections( );
        break;
      }
      case PLD_PORTAL:{
        payloadPortal( );
        break;
      }
      case PLD_REVERB:{
        payloadReverb( );
        break;
      }
      case PLD_AUDIO_PLUS:{
        payloadAudioPlus( );
        break;
      }
      case PLD_DISPERSION:{
        payload Dispersion( );
        break;
      }
      case PLD_VOX_DATA:{
        payloadVoxData( );
        break;
      }
      case PLD_SCENE:{
        payloadScene( );
        break;
      }
      case PLD_MPHOA:{
        payloadMPHOA( );
        break;
      }
```

In case of informed sources being dynamic (i.e. changing their position or different audio sources in the audio scene that become informed source), the information can be carried via the mpegiSceneUpdate( ) packet delivered as PACTYP_MPEGI_PLD MHAS packet. A new PLD type PLD_MPHOA carried in payloadMPHOA is presented above.
The configuration information for reduced computational complexity for MPHOA rendering can also be signaled as part of the PACTYP_MPEGI_CFG in the data structure mpegiSceneConfig( ) of MPEG-I ISO/IEC 23090-4 WDO version 2 which is extended and described below: The overrideFreqBandConfig flag equal to 1 indicates that the frequency band configuration delivered in the config packet is to be used and override the frequency band configuration defined by default in the renderer. The details of the frequency band configuration is described according to the HoaGroupFreqBandConfigStruct( ).

```
mpegiSceneConfig( ){
  unsigned int(16) entityCount;
  for(int i=0;i<entityCount;i++){
    unsigned int(8) integerId;
    cstring stringId;
  }
  unsigned int(3) delayBufferSize;
  unsigned int(3) gainCullingThreshold;
  unsigned int(1) overrideSpeedOfSound;
  if(overrideSpeedOfSound){
    unsigned int(13) speedOfSound;
  }
  unsigned int(1) overrideTemperature;
  if(overrideTemperature){
    unsigned int(5) temperature;
  }
  unsigned int(1) overrideFreqBandConfig;
  if(overrideFreqBandConfig){
    HoaGroupFreqBandConfigStruct( );
  }
}
```

The authoring device furthermore comprises an informed source rendering control parameters determiner 319 which is configured to obtain the HOA source audio data, the audio scene description (which can be in the form of Encoder Input Format (EIF) or any other suitable format), the User Reachable Region (URR) information which describes where the user or listener can experience the scene. In addition, the informed source information such as its position, priority (if known beforehand) is obtained. As further shown the informed rendering criteria such as the number of active informed sources, and distance threshold (which can be depending on the target consumption device computational resource availability), or informed source proximity threshold is determined. Additionally the informed source rendering control parameters determiner 319 can be configured to determine HOA source to informed source proximity threshold, and the maximum simultaneous active informed sources number.

In some embodiments the determiner 319 is configured to assign a priority based on the need to have a certain informed source active compared to the other expected simultaneously active informed source.

As described herein the authoring device is configured to generate information which enables the listener to move around with one or more informed sources active. The exact choice of which audio sources in the audio scene are of particular interest for a good subjective content consumption can be based on objective method such as hotspots of listener movement based on serendipitous consumption of the audio scene or based on content creator specified scene design.

The input to the MPEG-I encoder 323 to generate the bitstream containing the informed sources can be added to the encoder input format or any other suitable audio scene description which enables the MPEG-I encoder to determine the various informed source rendering configuration parameters. For example the following is an example of the EIF representation of the informed sources in a HOAGroup element in EIF:
<InformedSource id=“is:source1” position=“1.0 0.66-1.19”/>
<InformedSource id=“is:source2” position=“4.554 1.214-4.362”/>

The above is an example representation with a unique identifier which can be used to indicate subsequent scene updates (which can be either as timed update or dynamic late update arriving during runtime).

The encoder 303 in some embodiments is configured to obtain the informed source rendering control parameters and the other authoring device information and encode this to generate audio signals and associated metadata. For example in some embodiments the encoder comprise a MPEG-I encoder 323 which comprises an encoder 325 configured to encode the control data for the informed mode and generate a MPEG-I 6DoF bitstream.

The encoder further comprises a MPEG-H 3DA encoder 321 which is configured to encode the HOA source audio data to generate a MPEG-H 3DA audio data. Thus in other words the information derived from the authoring tool for informed source parameters such as priority, proximity threshold, etc. is delivered to an enhanced MPEG-I encoder to perform the encoding of the informed rendering control data encoding into the bitstream according to the specified format. The MPEG-I encoder 323 thus generates the MPEG-I 6DoF bitstream.

The encoded audio and metadata is passed to a server 305.

The server 305 is configured to receive the MPEG-16DoF bitstream 330 and MPEG-H 3DA audio data 332 and be able to output these to the playback device 307. The server 305 in other words hosts the MPEG-I 6DoF bitstream and the MPEG-H 3DA coded audio data (HOA sources).

The playback device 307 in some embodiments comprises player 399. The player comprises an audio data and MPEG-I bitstream decoder 345 configured to receive the MPEG-I 6DoF bitstream 330 and MPEG-H 3DA audio data 332 and output a decoded MPEG-I 6DoF bitstream to a informed rendering control data in bitstream determiner 345 which is configured to determine the informed rendering control data and pass this to the activate and deactivate informed source controller 341.

Additionally the activate and deactivate informed source controller 341 is configured to obtain the listener tracking information 340 (which can comprise position and orientation information from the head mounted device 309). The activate and deactivate informed source controller can thus use the listener position information in the audio scene and checks for a presence of hoaGroups( ) data structure to initiate 6DoF HOA rendering with multiple HOA sources. The presence of informed source information in the bitstream results in checking of the activation/deactivation parameters for the informed sources specified in the bitstream. Subsequently, informed rendering is initiated for the informed sources determined to be activated. The deactivation follows the thresholds specified in the bitstream. The activate and deactivate informed source controller 341 can then be configured to output a MPHOA rendering 348 based on the active and inactive sources.

In some embodiments the activate and deactivate informed source controller 341 is configured to determine a mean listener position PLₘₑₐₙ as the average of the current position PL_{current} and the position of the listener in the previous processing frame PLₚᵣₑᵥᵢₒᵤₛ:

$${PL}_{mean} = ( {PL}_{current} + {PL}_{previous} ) / 2$$

From the mean listener position, the distances to each informed source ASₙ are obtained:

$${D}_{{LtoAS}_{n}} - ‖ {P}_{AS} - {PL}_{mean} ‖$$

D_{LtoAs}_{ₙ} is the distance between the listener and the informed source ASₙ. The distance D_{LtoAs}_{ₙ} determines if the informed rendering for the source ASₙ is active or not. If the distance is smaller than the set maximum distance lpdInformedSourceEnableThreshold, the source is marked as a candidate to be an active source. In some embodiments a final decision on the active status is determined by how long the closest HOA source to the considered informed source, HOA_{AS}_{ₙ}, has been processed with STFT. If HOA_{AS}_{ₙ} has been processed long enough consecutively, i.e., for more than nTotalFramesTracked number of frames, the internal buffers for the STFT are flushed and the audio source ASₙ is marked as an active informed source. All the active informed sources are rendered with the informed mode processing. If no source is active, a conventional rendering is implemented.

In some embodiments the following pseudo code transcribes the process of determining the active informed sources in the activate and deactivate informed source controller 341:

### Terms for Describing the Algorithm:

HOA_{AS}_{ₙ} defines a closest HOA source to an informed source ASₙ transformedSourceArrays defines a list of all the HOA source that are processed through STFT for this frame
trackedSourceMicArrays defines a history of HOAs that are processed through STFT, that are bound to informed sources consecutively for nTotalFramesTracked trackedCurrentTriangleArrays defines a history of HOAs that are processed through STFT, that are bound to triangles consecutively for nTotalFramesTracked long
nTotalFramesTracked defines the number of frames required to process the STFT, before the internal buffers are flushed
activeSources defines active informed audio sources

```
if(D_{LtoAS}_{ₙ} < lpdInformedSourceEnableThreshold)
  - add HOA_{AS}_{ₙ} to transformedSourceArrays
  - add HOA_{AS}_{ₙ} to the beginning of trackedSourceMicArrays
  if (HOA_{AS}_{ₙ} in trackedSourceMicArrays[nTotalFramesTracked − 1] or
    HOA_{AS}_{ₙ} in trackedCurrentTriangleArrays[nTotal FramesTracked −
1])
      - mark ASₙ as an active source, add it to activeSources
...
- shift trackedSourceMicArrays and trackedCurrentTriangleArrays by one
frame at the end of the processing loop
```

The decoded audio data 344 from the audio data and MPEG-I bitstream decoder 345 can also be passed to a renderer 343 along with the MPHOA rendering 348 which enables the renderer 343 to generate a informed rendering of the binaural (or other output format) audio signals 342, which can be passed to the head mounted device 309.

With respect to FIG. 4 is shown an example operation of a renderer according to some embodiments.

An initial operation is to obtain MPEG-I bitstream as shown by 401.

Then a further operation is one of to perform a check for presence of informed source information as shown by 403.

Following this is performing a check for presence of max number of simultaneous informed sources (MaxSimulInformedSources) as shown by 405.

Then is performed as shown by 407 the extracting information for the informed source(s) in the bitstream.

A further check for presence of listener proximity threshold to the informed source(s) in the bitstream is shown by 409.

Following on is shown by 411 selecting the closest informed source (which is not rendered with Informed processing) within the proximity threshold from the listener.

After this is the operation, as shown by 413, of enabling informed rendering for the selected informed source within the proximity threshold from the listener.

Furthermore is the operation, as shown by 415, of selecting the closest HOA source with respect to the informed source but exclude HOA source(s) that are more than threshold distance away from the informed source.

Then a check is performed, as shown by 417, of has the chosen HOA been processed with STFT (or other suitable time-frequency transform) more than nTotalFramesTracked number of frames? This parameter can add a delay of nTotalFramesTracked with regards to making an informed source an active informed source. The typical implementation value is a few number of frames (typically less than 20), resulting in few tens of milliseconds in perceiving the informed source rendering subjective experience. This is imperceivable. In some embodiments, the nTotalFramesTracked is reduced for faster response time.

Where the answer to the check is ‘no’ then the operation may pass back to 411 and a further selection of the closest informed source. Where the answer is ‘yes’ then as shown by 419 is the operation of Initiate informed source render processing for the selected informed source and increment count of renderedInformedSources.

Following this is the operation of a check of Is renderedInformedSources<MaxSimulInformedSources as shown by 421. In some embodiments if MaxSimulInformedSources is reached or exceeded, the sources are ordered according to priorityValue or based on some other ordering (such as distance from the listener) and sources with low priority are removed until the number of sources are below MaxSimulInformedSources again. In some embodiments a further procedure can be implemented where there is a priorityValue tie.

Where the answer to the check is ‘yes’ then the operation passes back to 411, and where the answer is ‘no’ then the next operation is to stop enabling informed rendering for any more informed sources in the bitstream as shown by 423.

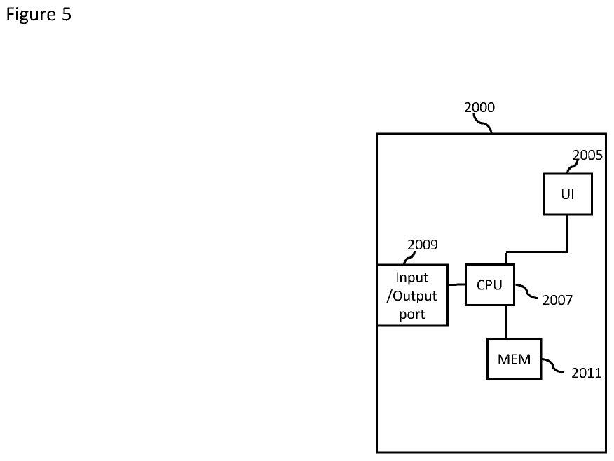

With respect to FIG. 5 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1609 may be configured to transmit/receive the audio signals, the bitstream and in some embodiments perform the operations and methods as described above by using the processor 1607 executing suitable code.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.
   This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for six degree-of-freedom rendering of an audio scene, the method comprising:
obtaining a spatial audio bitstream, the spatial audio bitstream comprising audio description metadata, the audio description metadata comprising information associated with at least one audio source, wherein the information comprises:
a position of the at least one audio source; and
at least one of:
an audio source priority, the audio source priority configured to define a priority of the at least one audio source within the audio scene; or
an audio source proximity threshold, the audio source proximity threshold defining a threshold distance within which the at least one audio source is present;
determining a listener position within the audio scene;
selecting the at least one audio source based on the listener position, the position of the at least one audio source, and at least one of: the audio source proximity threshold; or the audio source priority; and
rendering a spatial audio signal at least from the selected at least one audio source.

2-4. (canceled)

5. The method as claimed in claim 1, wherein the information associated with the at least one audio source comprises information configured to indicate at least one of:
which frequency bins are processed individually;
which frequency bins are merged into two or more groups; or
which frequency bins are merged into a single group;
wherein rendering the spatial audio signal from the selected at least one audio source comprises rendering the spatial audio signal based on processing the selected at least one audio source on a frequency bin basis determined from the information configured to indicate at least one of:
which frequency bins are processed individually;
which frequency bins are merged into two or more groups; or
which frequency bins are merged into the single group.

6. The method as claimed in claim 5, wherein the information comprises at least one of:
a highest frequency bin index configured to indicate the highest frequency bin index up to which frequency bins are processed individually;
a lowest frequency bin index configured to indicate the lowest frequency bin index above which frequency bins are merged and treated as a single frequency bin; or
a merge indicator configured to indicate a range of frequency bins in which frequency bins are merged and treated as the single frequency bin.

7-13. (canceled)

14. An apparatus for six degree-of-freedom rendering of an audio scene, the apparatus comprising:
at least one processor; and
at least one memory storing instructions that, when executed with the at least one processor, cause the apparatus at least to:
obtain a spatial audio bitstream, the spatial audio bitstream comprising audio description metadata, the audio description metadata comprising information associated with at least one audio source, wherein the information comprises:
a position of the at least one audio source; and
at least one of:
an audio source priority, the audio source priority configured to define a priority of the at least one audio source within the audio scene; or
an audio source proximity threshold, the audio source proximity threshold defining a threshold distance within which the at least one audio source is present;
determine a listener position within the audio scene;
select the at least one audio source based on the listener position, the position of the at least one audio source and at least one of: the audio source proximity threshold; or the audio source priority; and
render a spatial audio signal at least based on the selected at least one audio source.

15. The apparatus as claimed in claim 14, wherein the audio source priority is based on at least one of:
a determination of the at least one audio source position relative to a user reachable region; or
a determination of a user input or other input audio source priority value.

16. The apparatus as claimed in claim 14, wherein the audio scene comprises at least two higher order ambisonics sources.

17. The apparatus as claimed in claim 16, wherein the audio source proximity threshold is based on at least one of:
an audio level associated with the at least one audio source;
a distance between at least one of the at least two higher order ambisonics sources and the at least one audio source;
a distance between the listener and the at least one audio source; or
a user input or other input audio source proximity threshold value.

18. The apparatus as claimed in claim 14,
wherein the information is configured to indicate at least one of:
which frequency bins are processed individually;
which frequency bins are merged into two or more groups; or
which frequency bins are merged into a single group,
wherein rendering the spatial audio signal from the selected at least one audio source causes the instructions, when executed with the at least one processor, to cause the apparatus to render the spatial audio signal based on processing the selected at least one audio source on a frequency bin basis determined from the information configured to indicate at least one of:
which frequency bins are processed individually;
which frequency bins are merged into two or more groups; or
which frequency bins are merged into the single group.

19. The apparatus as claimed in claim 18, wherein the information comprises at least one of:
a highest frequency bin index configured to indicate the highest frequency bin index up to which frequency bins are processed individually;
a lowest frequency bin index configured to indicate the lowest frequency bin index above which frequency bins are merged and treated as a single frequency bin; or
a merge indicator configured to indicate a range of frequency bins in which frequency bins are merged and treated as the single frequency bin.

20. The apparatus as claimed in claim 14, wherein the instructions, when executed with the at least one processor, cause the apparatus to at least one of:
determine two or more audio sources, wherein the two or more audio sources are within a range defined with the position of the listener and the audio source proximity threshold; or
select, from the two or more audio sources, the at least one audio source based on at least one of: the audio source priority; or a distance between the audio source position and the listener position.

21-24. (canceled)

25. The method as claimed in claim 1, wherein the audio source priority is based on at least one of:
a determination of the at least one audio source position relative to a user reachable region; or
a determination of a user input or other input audio source priority value.

26. The method as claimed in claim 1, wherein the audio scene comprises at least two higher order ambisonics sources.

27. The method as claimed in claim 1, wherein the audio source proximity threshold is based on at least one of:
an audio level associated with the at least one audio source;
a distance between at least one of: the at least two higher order ambisonics sources; or the at least one audio source;
a distance between the listener and the at least one audio source; or
a user input or other input audio source proximity threshold value.

28. The method as claimed in claim 1, wherein selecting the at least one audio source comprises at least one of:
determining two or more audio sources, wherein the two or more audio sources are within a range defined with the position of the listener and the audio source proximity threshold; or
selecting, from the two or more audio sources, the at least one audio source based on at least one of: the audio source priority; or a distance between the audio source position and the listener position.

29. A non-transitory program storage device readable with an apparatus tangibly embodying a program of instructions executable with the apparatus for performing operations, the operations comprising:
obtaining a spatial audio bitstream, the spatial audio bitstream comprising audio description metadata, the audio description metadata comprising information associated with at least one audio source, wherein the information comprises:
a position of the at least one audio source; and
at least one of:
an audio source priority, the audio source priority configured to define a priority of the at least one audio source within the audio scene; or
an audio source proximity threshold, the audio source proximity threshold defining a threshold distance within which the at least one audio source is present;
determining a listener position within the audio scene;
selecting the at least one audio source based on the listener position, the position of the at least one audio source, and at least one of: the audio source proximity threshold; or the audio source priority; and
rendering a spatial audio signal at least based on the selected at least one audio source.

30. The non-transitory program storage device as claimed in claim 29, wherein the audio source priority is based on at least one of:
a determination of the at least one audio source position relative to a user reachable region; or
a determination of a user input or other input audio source priority value.

31. The non-transitory program storage device as claimed in claim 29, wherein the audio scene comprises at least two higher order ambisonics sources and the audio source proximity threshold is based on at least one of:
an audio level associated with the at least one audio source;
a distance between at least one of: the at least two higher order ambisonics sources; or the at least one audio source;
a distance between the listener and the at least one audio source; or
a user input or other input audio source proximity threshold value.

32. The non-transitory program storage device as claimed in claim 29, wherein the information is configured to indicate at least one of:
which frequency bins are processed individually;
which frequency bins are merged into two or more groups; or
which frequency bins are merged into a single group;
wherein rendering the spatial audio signal from the selected at least one audio source causes the apparatus to render the spatial audio signal based on processing the selected at least one audio source on a frequency bin basis determined from the information configured to indicate at least one of:
which frequency bins are processed individually;
which frequency bins are merged into two or more groups; or
which frequency bins are merged into the single group.

33. The non-transitory program storage device as claimed in claim 29, wherein the information comprises at least one of:
a highest frequency bin index configured to indicate the highest frequency bin index up to which frequency bins are processed individually;
a lowest frequency bin index configured to indicate the lowest frequency bin index above which frequency bins are merged and treated as a single frequency bin; or
a merge indicator configured to indicate a range of frequency bins in which frequency bins are merged and treated as the single frequency bin.

34. The non-transitory program storage device as claimed in claim 29, wherein the apparatus is caused to at least one of:
determine two or more audio sources, wherein the two or more audio sources are within a range defined with the position of the listener and the audio source proximity threshold; or
select, from the two or more audio sources, the at least one audio source based on at least one of: the audio source priority; or a distance between the audio source position and the listener position.
